(19) United States
(12) Patent Application Publication
(10) Pub. No.: US 2007/0216192 A1
(43) Pub. Date: Sep. 20, 2007

(54) Sublimated vehicle cover apparatus

(76) Inventor: John Aldrich, Camarillo, CA (US)

Correspondence Address: MCDERMOTT WILL & EMERY LLP, 2049 CENTURY PARK EAST, 38th Floor, LOS ANGELES, CA, 90067-3208, US

(21) Appl. No.: 11/366,111

(22) Filed: Mar. 1, 2006

(51) Int. Cl. B60J 7/20

(52) U.S. Cl. 296/136.1

(57) ABSTRACT

A vehicle cover apparatus produced by a sublimation process. The sublimation method includes providing a substantially polyester material. The material may be tricot. The material is cut into pieces that, when assembled together, are configured in substantially the shape of a vehicle. A computerized image is provided so that it may be transferred to at least one piece of the substantially polyester material. A printing device is also provided, and this printing device is configured to transfer the computerized image to paper, wherein the printing device includes ink. Paper is provided that, when heated, transfers the pigment from the paper to the at least one piece of the substantially polyester material to provide a sublimated material. When the pigment is transferred to all pieces of substantially polyester material, the pieces are assembled to cover the vehicle. The vehicle cover may be chemically treated to render it antimicrobial and UV-resistant.

### BACKGROUND OF THE INVENTION

1. Field of Invention

The present disclosure relates to protective coverings for vehicles and, more particularly, to protective coverings that are suitable for high-definition printed graphics.

2. Description of Related Art

Vehicle covers are often used by the average person, the car enthusiast and those in between. Vehicle covers may be used to provide protection for an automobile, including protection from dust and scratches.

Current vehicle covers are commonly manufactured using a silk screening process. Silk screening generally involves placing ink or pigment on the surface of yarn or fabric. However, silk screening provides disadvantages in that the pigment may seep through the vehicle cover and damage the vehicle. Moreover, silk screening tends to wear off or degrade. Still further silk-screening affects the ability of the cover to breathe. Silk screening is not adaptable to imaging in that it does not permit substantial resolution of the image transferred during the silk screening process.

Sublimation is a process has been used in the apparel industry to apply graphics onto fabric. Sublimation may be performed using a heat induced process that places pigment within the yarn fiber itself unlike screen printing that places pigment on the surface of the yarn or fabric. Most common sublimation uses are in the apparel industry. Some items utilizing sublimation include: board-shorts, trunks, shirts, skirts, sarongs, bandanas, footwear insoles, jackets, garment linings, etc. Sublimation provides an image with photo-real definition.

There is a need for a vehicle cover that does not damage a car by permitting pigment to seep through the vehicle cover.

There is further a need for a vehicle cover that provides high graphic definition and is aesthetically superior to prior art vehicle covers.

There is still further a need for a vehicle cover that holds the graphic image.

### BRIEF SUMMARY OF INVENTION

The present disclosure addresses the foregoing deficiencies of the prior art by providing a vehicle cover apparatus that yields a fabric with high graphic definition, that is ultra-soft and scratch resistant, has a relative inability to hold dirt and debris when compared to silk screening, and has no discernable feel of pigment or indication that it is a printed textile.

In accordance with one embodiment of the present disclosure, a vehicle cover apparatus is provided. The vehicle cover apparatus comprises a substantially polyester material composed of a multi-part pattern, wherein each part of the multi-part pattern is stitched to another part of the multi-part pattern, and wherein the substantially polyester material is configured to substantially cover the top and side surfaces of a vehicle. The apparatus also comprises pigment that is applied to the substantially polyester material via paper that, when heated, causes the pigment to be transferred from the paper to the substantially polyester material.

In accordance with another embodiment of the present disclosure, a method is provided for producing a sublimated vehicle cover apparatus. The method comprises providing a substantially polyester material. The method further comprises cutting the substantially polyester material into a multi-part pattern that, when assembled together, is configured to cover the top and side surfaces of a vehicle.

The method also comprises providing a computerized image to be transferred to at least one part of the multi-part pattern of the substantially polyester material, and providing a printing device configured to transfer the computerized image to paper, wherein the printing device includes pigment. The method further includes providing paper that when heated, is configured to transfer pigment from the paper to the at least one part of the multi-part pattern of the substantially polyester material, and heating the paper so that the pigment is transferred from the paper to the at least one part of the multi-part pattern of the substantially polyester material. Finally, the method includes stitching the multi-part pattern together to form a vehicle cover that substantially covers the top and side surfaces of the vehicle.

In accordance with yet another embodiment of the present disclosure, a system is provided for producing a sublimated vehicle cover apparatus. The system includes a substantially polyester material in an amount sufficient to cover a vehicle's top and side surfaces, cutting means for cutting the substantially polyester material into parts that, when assembled together, are configured in substantially the shape of the top and side surfaces of a vehicle. The system further includes a computerized image configured to be transferred to at least one part of the substantially polyester material, transfer means configured to transfer a computerized image to at least one part of the substantially polyester material, a printing device configured to transfer the computerized image to paper, wherein the printing device includes pigment.

The system further comprises paper that when heated, is configured to transfer pigment from the paper to the at least one part of the substantially polyester material, heating means for heating the paper so that the pigment is transferred from the paper to the at least one part of the substantially polyester material, and machine-stitching the multi-part pattern together to form a vehicle cover that substantially covers the top and side of the vehicle.

These, as well as other objects, features and benefits will now become clear from a review of the following detailed description of illustrative embodiments and the accompanying drawings.

### BRIEF DESCRIPTION OF DRAWINGS

FIG. 1 is a flow chart representation of a sublimation method for producing a vehicle cover apparatus in accordance with one embodiment of the present disclosure.

FIG. 2 is an example of a vehicle cover apparatus that was produced using the sublimation method in accordance with one embodiment of the present disclosure.

### DETAILED DESCRIPTION OF ILLUSTRATIVE EMBODIMENTS

The vehicle cover apparatus of the present disclosure may be used to protect against sunlight, dust, dew, ozone, and light atmospheric debris. The cover is designed with a primary focus on the aesthetic. The vehicle cover apparatus of the present disclosure may be used to cover his or her vehicle when the vehicle is garaged.

The present disclosure provides for a vehicle cover apparatus that is produced using a sublimation process. A combination of tricot and sublimation in accordance with the present disclosure may yield a fabric with high graphic definition, scratch resistance, the relative inability to hold dirt and debris, and have no discernable feel of pigment or indication that it is a printed textile.

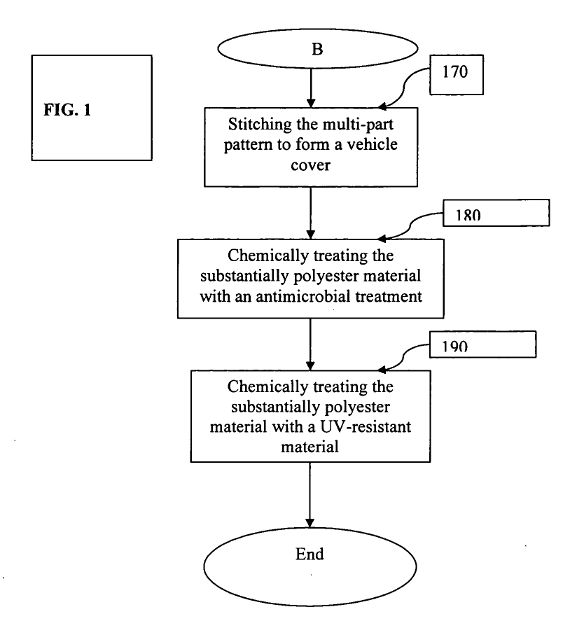

Referring now to FIG. 1, illustrated is a flow chart 100 for producing a car cover via sublimation. At step 110, a sufficient amount of substantially polyester or tricot material is provided for producing the vehicle cover. It may be desirable to use a material or fabric that has a 100% polyester yarn content. Materials having a high polyester content may produce a more aesthetically pleasing printing result. The fabric used for the may be polyester “tricot,” a woven polyester that having a degree of mechanical stretch. This tricot may have a very smooth top surface (“face”), and a knapped or brushed back surface. Variations of tricot may be differentiated by weight, face type, backside type, and yarn denier. Denier is the unit of measure that may be used to define the size of a fiber for making yarn and ultimately a textile.

Variations in polyester yarn content for this substantially polyester material may range from seventy-five percent (75%) polyester to one hundred percent (100%) polyester. Other materials that may be included along with the polyester include cotton, nylon, rayon, MYLAR™ fabric, spandex, LYCRA™ fabric, urethane, and polyurethane content.

At step 120, the substantially polyester material may be cut into a multi-part pattern that, when assembled, may be configured in substantially the shape of the top and side surfaces of a vehicle. Electric knives and scissors may be used to hand-cut the fabric into the predetermined pattern shapes. These shapes may be determined based on the contours of the vehicle and the vehicle surfaces over which the shape will lie. Dozens of pattern shapes may be needed for a single vehicle. Other items such as grommets may be used along with the fabric. A grommet is a reinforced eyelet through which a fastener may be passed. Numerous additional items may be incorporated into the vehicle cover apparatus, including, but not limited to, elastic, VELCRO™ fastenings, labeling, badges, straps, etc.

At step 130, a computerized image is provided to be transferred to at least one part of the substantially polyester material. The computerized image may be created using image creation and/or editing software. Such image software may include ADOBE™ ILLUSTRATOR™ and PHOTOSHOP™ image creation and/or editing software. Each image may be sized according to a pre-determined pattern shape. Each pattern shape may be determined by measuring the body surface of the vehicle to be covered.

At step 140, paper is provided for the purpose of transferring pigment to the at least one piece of substantially polyester material, once the paper is heated. The paper may be digitized paper that contains the pigment substrate to form a reverse image. It should be noted that digitized sublimation may also be used for production of the vehicle cover. Using this method, a soft mold is created for prototypes. Aluminum may be used to create this soft mold. Then, a production quality mold, e.g., one made of stainless steel, may be used because the stainless steel mold may have a longer life span than an aluminum mold.

At step 150, a printing device configured to transfer the computerized image to paper. The printing device includes pigment that is configured to transfer the image from paper to the at least one piece of substantially polyester material, once the paper is heated. The printing device may be any printer suitable to print the pigment onto the paper. The printing device may include a general purpose computer having an attached printer. The attached printer may be configured to print the type of pigment necessary to transfer the image to the substantially polyester material. The computer may have a processor, sufficient random access memory (RAM) and random operating memory (ROM), and an operating system configured to operate the image creation and/or editing software. The computer may also include a display device for displaying the computerized image and input devices for inputting commands, e.g., print commands. The computer may also include storage media for storing instructions related to creating and editing the computerized image as well as storage for the actual images.

At step 155, the image is printed onto the paper. At step 160, via sublimation, the paper is heated so that the pigment is transferred from the paper to the at least one piece of substantially polyester material. Sublimation may be described as a heat-induced process that places pigment within the yarn fiber itself unlike screen printing that places pigment merely on the surface of the yarn or fabric. Once the pigment is transferred onto the fabric, a sublimated graphic pattern is provided. The paper that includes the image may be transferred manually onto particular pieces of the at least one piece of substantially polyester material. The location onto which the pattern will be transferred may be determined by the person applying the pattern.

At step 170, the multi-part pattern is stitched to cover to form a vehicle cover. Vehicle covers for specified types of vehicles may be prototyped several times until the design has been perfected.

The vehicle cover of the present disclosure, which is produced via a combination of tricot and sublimation, yields a fabric with high, photo-real graphic definition, scratch resistance, the relative inability to hold dirt and debris, and has no discernable feel of pigment or indication that it is a printed textile.

At step 180, the final sublimated fabric used for this cover may be chemically treated to render it “anti-microbial” and to prohibit the yarn from harboring bacteria and consequently generating mold/mildew.

Moreover, at step 190, the final sublimated fabric used for this cover may also be chemically treated to render it UV-resistant. Ultraviolet resistance may add longevity to the graphic as well as the yarn structure.

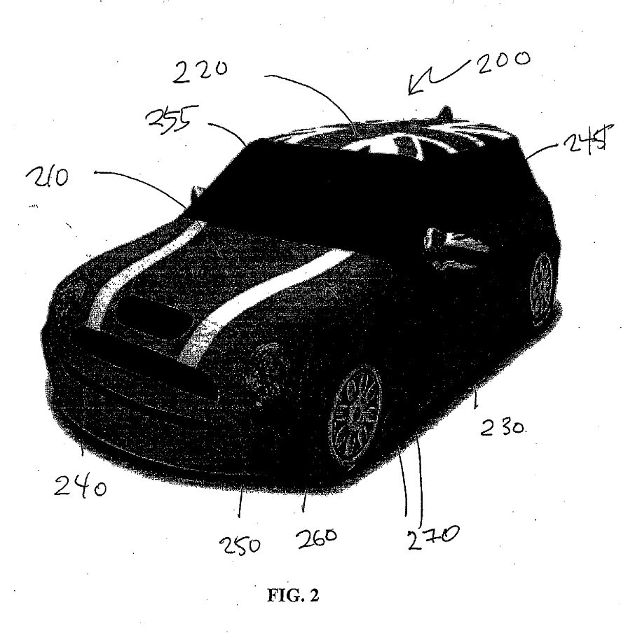

Referring now to FIG. 2, illustrated is an example of a vehicle cover produced via sublimation in accordance with the present disclosure. As shown vehicle cover 200 includes top surfaces 220, 210 and side surfaces 240, 255, 230, 245 as well as right side surfaces (not shown) and back side surfaces (not shown). The vehicle cover is stylized with a high-definition graphic pattern applied via a heating process. The graphic pattern includes photo-real wheels, a grill and lights on the front side surface 240. On the hood is a British flag, in accordance with the theme of the vehicle cover which happens to be for a MINI COOPER™ vehicle, a vehicle manufactured in Britain. Machine stitching 270 is shown where the multi-part pattern for the vehicle has been stitched together.

While the specification describes particular embodiments of the present invention, those of ordinary skill can devise variations of the present invention without departing from the inventive concept.

We claim:

1. A sublimated vehicle cover apparatus, comprising:
a substantially polyester material composed of a multi-part pattern, wherein each part of the multi-part pattern is stitched to another part of the multi-part pattern, and wherein the substantially polyester material is configured to substantially cover the top and side surfaces of a vehicle; and
pigment that is applied to the substantially polyester material via paper that, when heated, causes the pigment to be transferred from the paper to the substantially polyester material.

2. The apparatus of claim 1, wherein the substantially polyester material is tricot.

3. The apparatus of claim 1, further comprising:
antimicrobial treatment configured to protect the vehicle cover apparatus from bacteria and/or mildew.

4. The apparatus of claim 1, further comprising:
ultraviolet-resistant treatment configured to protect the vehicle cover apparatus from damage associated with ultraviolet rays.

5. A method for producing a sublimated vehicle cover apparatus, comprising:
providing a substantially polyester material;
cutting the substantially polyester material into a multi-part pattern that, when assembled together, is configured to cover the top and side surfaces of a vehicle;
providing a computerized image to be transferred to at least one part of the multi-part pattern of the substantially polyester material;
providing a printing device configured to transfer the computerized image to paper, wherein the printing device includes pigment; providing paper that when heated, is configured to transfer pigment from the paper to the at least one part of the multi-part pattern of the substantially polyester material;
printing the image onto the paper;
heating the paper so that the pigment is transferred from the paper to the at least one part of the multi-part pattern of the substantially polyester material; and
stitching the multi-part pattern together to form a vehicle cover that substantially covers the top and side surfaces of the vehicle.

6. The method of claim 5, wherein the substantially polyester material is tricot.

7. The method of claim 5, further comprising:
applying an antimicrobial treatment configured to protect the vehicle cover apparatus from bacteria and/or mildew.

8. The method of claim 5, further comprising:
applying an ultraviolet-resistant treatment configured to protect the vehicle cover apparatus from damage associated with ultraviolet rays.

9. A system for producing a sublimated vehicle cover apparatus, comprising:
a substantially polyester material in an amount sufficient to cover a vehicle's top and side surfaces;
cutting means for cutting the substantially polyester material into parts that, when assembled together, are configured in substantially the shape of the top and side surfaces of the vehicle;
a computerized image configured to be transferred to at least one part of the substantially polyester material;
transfer means configured to transfer pigment to at least one part of the substantially polyester material;
a printing device configured to transfer the computerized image to paper, wherein the printing device includes pigment;
heating means for heating the paper so that the pigment is transferred from the paper to the at least one part of the substantially polyester material; and
machine-stitching the multi-part pattern together to form a vehicle cover that substantially covers the top and side of the vehicle.

10. The system of claim 9, wherein the substantially polyester material is tricot.

11. The system of claim 9, further comprising:
antimicrobial treatment configured to protect the vehicle cover apparatus from bacteria and/or mildew.

12. The system of claim 9, further comprising:
ultraviolet-resistant treatment configured to protect the vehicle cover apparatus from damage associated with ultraviolet rays.

13. The system of claim 9, wherein the transfer means includes paper that when heated, is configured to transfer pigment from the paper to the at least one part of the substantially polyester material.
